(19) United States
(12) Patent Application Publication
(10) Pub. No.: US 2026/0347638 A1
(43) Pub. Date: Nov. 5, 2026

(54) COATING COMPOSITION CONTAINING BIO-DERIVED COMPONENT AND AUTOMOTIVE INTERIOR MATERIAL INCLUDING SAME

(71) Applicants: HYUNDAI MOTOR COMPANY, Seoul (KR); KIA CORPORATION, Seoul (KR); NOROO Paint & Coatings Co., Ltd., Anyang-si (KR)

(72) Inventors: Hyun Jung Kim, Hwaseong-si (KR); Seon Ho Jang, Hwaseong-si (KR); Ho Tak Jeon, Hwaseong-si (KR); Hyeon Woo Kim, Hwaseong-si (KR); Seung Jae Lee, Ansan-si (KR); Hyun Yong Oh, Seoul (KR); Eui Yong Kim, Seoul (KR)

(73) Assignees: HYUNDAI MOTOR COMPANY, Seoul (KR); KIA CORPORATION, Seoul (KR); NOROO Paint & Coatings Co., Ltd., Anyang-si (KR)

(21) Appl. No.: 19/391,839

(22) Filed: Nov. 17, 2025

(30) Foreign Application Priority Data
May 2, 2025 (KR) 10-2025-0058069

(51) Int. Cl. C09D 133/06

(52) U.S. Cl. CPC C09D 133/066

(57) ABSTRACT

A coating composition containing a bio-derived component and an automotive interior material including the same is provided. Further, an automotive interior material including a substrate and a coating layer including a multilayer structure located on the substrate is provided. The coating layer includes a bottom layer on the substrate, a middle layer on the bottom layer, and a top layer on the middle layer. At least one of the bottom layer or the top layer includes the coating composition.

### CROSS-REFERENCE TO RELATED APPLICATION

This application claims, under 35 U.S.C. § 119(a), priority to Korean Patent Application No. 10-2025-0058069, filed on May 2, 2025, the entire contents of which are incorporated herein by reference.

### FIELD

Various aspects relate to a coating composition containing a bio-derived component and an automotive interior material including the same.

### BACKGROUND

The statements in this section merely provide background information related to the present disclosure and may not constitute prior art.

As interest in the environment has increased, many efforts are being made in various fields to reduce emission of carbon dioxide, which is pointed out as the main culprit of global warming. Accordingly, bio-materials are receiving attention as a replacement for existing oil and coal resources.

Bio-materials do not increase the amount of carbon dioxide in the atmosphere because the sum of carbon dioxide emissions and absorption in the life cycle on Earth is zero. In addition, the use thereof is an essential choice not only for environmental reasons but also to replace petroleum resources that are being depleted.

As the development of eco-friendly vehicles becomes more active, the need for automotive interior materials with high bio-material content is increasing. Bio-resin inherently has inferior properties compared to petroleum-derived resin, and thus, as the amount of the bio-resin increases, it becomes difficult to provide the properties required for automotive interior materials, such as appearance, scratch resistance, sunscreen resistance, moisture resistance, light resistance, and the like.

### SUMMARY

Various aspects of the present disclosure provide a coating composition capable of providing durability properties required for automobiles and increasing the bio-based carbon content in paint.

Another aspect is to provide a coating composition having excellent coating properties such as adhesion, sunscreen resistance, heat resistance, moisture resistance, light resistance, and the like.

Various aspects are not limited to the foregoing. Various aspects should be clearly understood through the following description and to be realized by the means described in the claims and combinations thereof.

Various aspects may provide a coating composition including a bio-derived acrylic resin and a bio-derived modified acrylic resin.

The bio-derived acrylic resin may have a bio-based carbon content in a range of 30 wt % to 35 wt %.

An acid value of the bio-derived acrylic resin may be in a range of 2 mgKOH/g to 5 mgKOH/g.

A hydroxyl value of the bio-derived acrylic resin may be in a range of 60 mgKOH/g to 80 mgKOH/g.

A glass transition temperature (Tg) of the bio-derived acrylic resin may be in a range of 80 °C to 100 °C.

A weight average molecular weight (Mw) of the bio-derived acrylic resin may be in a range of 9,000 g/mol to 13,000 g/mol.

A solid content of the bio-derived acrylic resin may be in a range of 40 wt % to 50 wt %.

The bio-derived acrylic resin may include a polymer of a bio-derived monomer including one or more of butyl acrylate, butyl methacrylate, ethyl acrylate, ethyl methacrylate, isobornyl acrylate, isobornyl methacrylate, isobutyl acrylate, isobutyl methacrylate, lauryl acrylate or lauryl methacrylate.

The bio-derived modified acrylic resin may have a bio-based carbon content in a range of 30 wt % to 40 wt %.

An acid value of the bio-derived modified acrylic resin may be 2 mgKOH/g or less.

A hydroxyl value of the bio-derived modified acrylic resin may be in a range of 125 mgKOH/g to 145 mgKOH/g.

A glass transition temperature (Tg) of the bio-derived modified acrylic resin may be in a range of 40 °C to 50 °C.

A weight average molecular weight (Mw) of the bio-derived modified acrylic resin may be in a range of 3,000 g/mol to 6,000 g/mol.

A solid content of the bio-derived modified acrylic resin may be in a range of 60 wt % to 80 wt %.

The bio-derived modified acrylic resin may include; a polymer of a bio-derived monomer including one or more of butyl acrylate, butyl methacrylate, ethyl acrylate, ethyl methacrylate, isobornyl acrylate, isobornyl methacrylate, isobutyl acrylate, isobutyl methacrylate, lauryl acrylate or lauryl methacrylate; and a diol compound modified with maleic anhydride.

The coating composition may further include a curing agent, in which the curing agent may include a bio-derived isocyanate curing agent.

The coating composition may include a main material and a curing agent. In particular, the main material may include a range of 10 wt % to 20 wt % of a base resin, a range of 25 wt % to 35 wt % of the bio-derived acrylic resin, a range of 10 wt % to 25 wt % of the bio-derived modified acrylic resin, a range of 1 wt % to 3 wt % of a pigment, a range of 15 wt % to 25 wt % of a solvent, and a range of 5 wt % to 20 wt % of an additive. The coating composition may include a range of 20 parts by weight to 30 parts by weight of the curing agent based on 100 parts by weight of the main material.

The coating composition may include a main material and a curing agent. In particular, the main material may include a range of 30 wt % to 45 wt % of the bio-derived acrylic resin, a range of 15 wt % to 25 wt % of the bio-derived modified acrylic resin, a range of 25 wt % to 40 wt % of a solvent, and a range of 2 wt % to 15 wt % of an additive. The coating composition may include 20 parts by weight to 30 parts by weight of the curing agent based on 100 parts by weight of the main material.

The coating composition may have a bio-based carbon content in a range of 15 wt % to 45 wt %.

Various aspects may provide an automotive interior material including a substrate and a coating layer having a multilayer structure located on the substrate, in which the coating layer includes a bottom layer on the substrate, a middle layer on the bottom layer, and a top layer on the middle layer, and at least one of the bottom layer or the top layer includes the coating composition described above.

### BRIEF DESCRIPTION OF THE DRAWING

FIG. 1 shows an automotive interior material according to an embodiment of the present disclosure.

### DETAILED DESCRIPTION

Various aspects of the present disclosure should be more clearly understood from the following embodiments taken in conjunction with the accompanying drawings. However, Various aspects are not limited to the embodiments disclosed herein, and may be modified into different forms. These embodiments are provided to thoroughly explain the disclosure and to sufficiently transfer the spirit of various aspects to those having ordinary skill in the art.

Throughout the drawings, the same reference numerals refer to the same or like elements. For the sake of clarity of the present disclosure, the dimensions of structures are depicted as being larger than the actual sizes thereof.

It should be further understood that the terms “comprise”, “include”, “have”, and the like, when used in this specification, specify the presence of stated features, integers, steps, operations, elements, components, or combinations thereof, but do not preclude the presence or addition of one or more other features, integers, steps, operations, elements, components, or combinations thereof. Also, it should be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

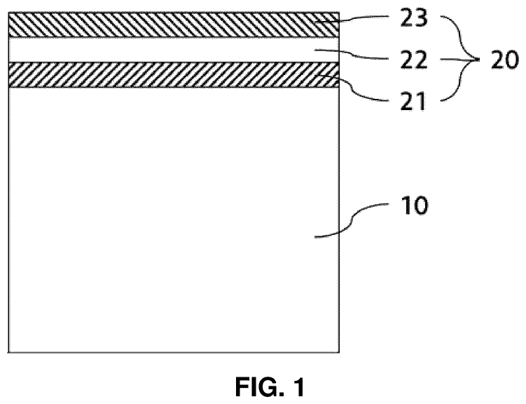

FIG. 1 is a cross-sectional view showing an automotive interior material according to an embodiment of the present disclosure. The automotive interior material may include a substrate 10 and a coating layer 20 having a multilayer structure applied onto the substrate 10.

The substrate 10 may include acrylonitrile butadiene styrene, a copolymer of polycarbonate and acrylonitrile butadiene styrene, and the like. The substrate 10 may be injection molded.

The coating layer 20 may include a bottom layer 21 disposed on the substrate 10, a middle layer 22 disposed on the bottom layer 21, and a top layer 23 disposed on the middle layer 22.

The bottom layer 21 may serve to reinforce the surface of the substrate 10 and increase adhesion between the substrate 10 and the coating layer 20. The bottom layer 21 may be formed by a hydraulic transfer method.

The middle layer 22 is a layer that determines color, appearance, and the like, and may serve to impart the coating layer 20 with resistance to environmental factors such as weather resistance, UV resistance, and the like. The middle layer 22 may be a film.

The top layer 23 serves to form a visible appearance and protect the inner components from the external environment. The top layer 23 may be glossy or matte. The top layer 23 may be formed by a hydraulic transfer method.

The coating composition may be applied to at least one of the bottom layer 21 or the top layer 23.

The coating composition may include a bio-derived acrylic resin, a bio-derived modified acrylic resin, a solvent, a curing agent, and the like.

The bio-derived acrylic resin may refer to acrylic resin that is manufactured using raw materials derived from renewable resources. While conventional acrylic resins may be synthetic polymers derived from petrochemical products, bio-derived acrylic resins are produced using biomass extracted from plant-based materials like corn or sugarcane.

The bio-derived acrylic resin may have a bio-based carbon content of about 30 wt % to 35 wt % based on the total amount of the bio-derived acrylic resin.

The bio-based carbon content may be measured using a radiocarbon analysis technique according to ASTM D6866 (% bio-based carbon content). Accurate biomass content may be measured according to the ASTM D6866 test standard. Radiocarbon (C₁₄), an isotope of carbon, exists only in biomass materials and not in petrochemical resins. The bio-based carbon content of a specimen may be calculated from the radiocarbon content of the specimen.

The bio-based carbon content may be determined according to EN 16640. The EN 16640 standard also allows for the determination of the proportions of bio-based carbon and fossil-based carbon in a sample based on radiocarbon dating.

According to ASTM D6866, total organic carbon content (X_{B}^{TOC}) may be determined, and according to EN 16640, total carbon content (X_{B}^{TC}) may be determined. For example, in 10 g of Product A having the components as shown in Table 1 below, the total organic carbon content (X_{B}^{TOC}) according to ASTM D6866 may be 25.9% (=1.5/1.5+4.3)) and the total carbon content (X_{B}^{TC}) according to EN 16640 may be 24.8% (=1.5/1.5+4.3+0.24)). However, the examples below are intended to illustrate the difference between ASTM D6866 and EN 16640, and in most cases the total organic carbon content (X_{B}^{TOC}) according to ASTM D6866 and the total carbon content (X_{B}^{TC}) according to EN 16640 are the same.

TABLE 1

| Classification | Weight [g] | Carbon weight [g] |
|---|---|---|
| PLA (polylactic acid) | 3 | 1.5 |
| PP (polypropylene) | 5 | 4.3 |
| CaCO₃ | 2 | 0.24 |

The bio-based carbon content of the bio-derived acrylic resin is the total organic carbon content (X_{B}^{TOC}) as measured according to ASTM D6866.

The acid value of the bio-derived acrylic resin may be in a range of 2 mgKOH/g to 5 mgKOH/g. The hydroxyl value of the bio-derived acrylic resin may be in a range of 60 mgKOH/g to 80 mgKOH/g. If the acid value and/or hydroxyl value are less than the lower limits of the above numerical ranges, adhesion between the substrate 10 and the coating layer 20 may decrease, and curing reaction may occur incompletely, resulting in a decrease in the curing speed or strength. On the other hand, if the acid value and/or hydroxyl value exceed the upper limits of the above numerical ranges, curing reaction may occur excessively, which may reduce the stability of the coating composition, and the viscosity of the coating composition may increase, making coating difficult. The acid and hydroxyl values may be calculated based on the number of milligrams of potassium hydroxide required to titrate a sample with a potassium hydroxide solution.

The glass transition temperature (Tg) of the bio-derived acrylic resin may be in a range of 80 °C to 100 °C. If the glass transition temperature is lower than 80 °C, the coating composition may become too flexible, resulting in poor adhesion or mechanical properties and reduced resistance to the external environment. On the other hand, if the glass transition temperature exceeds 100 °C, flexibility may decrease and durability may deteriorate.

The weight average molecular weight (Mw) of the bio-derived acrylic resin may be in a range of 9,000 g/mol to 13,000 g/mol. When the weight average molecular weight falls within the above numerical range, a coating film may be formed well from the coating composition and mechanical properties may be improved.

The bio-derived acrylic resin may be in a form mixed with an organic solvent. The solid content of the bio-derived acrylic resin may be in a range of 40 wt % to 50 wt % based on the total amount of the bio-derived acrylic resin. When the solid content falls within the above range, spray workability of the coating composition may be excellent. If the solid content is less than 40 wt %, the amount of the resin in the coating composition may decrease, so the coating film may not be properly formed, resulting in deteriorated mechanical properties.

The bio-derived acrylic resin may include a polymer of a bio-derived monomer including at least one of butyl acrylate, butyl methacrylate, ethyl acrylate, ethyl methacrylate, isobornyl acrylate, isobornyl methacrylate, isobutyl acrylate, isobutyl methacrylate, lauryl acrylate, or lauryl methacrylate.

The bio-derived modified acrylic resin may have a bio-based carbon content of in a range of 30 wt % to 40 wt % based on the total amount of the bio-derived modified acrylic resin.

The bio-based carbon content may be measured using a radiocarbon analysis technique according to ASTM D6866 (% bio-based carbon content). The bio-based carbon content may be determined according to EN 16640. The bio-based carbon content of the bio-derived modified acrylic resin is the total organic carbon content (X_{B}^{TOC}) as measured according to ASTM D6866.

The acid value of the bio-derived modified acrylic resin may be 2 mgKOH/g or less. The lower limit of the acid value is not particularly limited, and may be greater than 0 mgKOH/g, 0.1 mgKOH/g or more, or 0.5 mgKOH/g or more. The hydroxyl value of the bio-derived modified acrylic resin may be in a range of 125 mgKOH/g to 145 mgKOH/g. If the acid value and/or hydroxyl value are less than the lower limits of the above numerical ranges, adhesion between the substrate 10 and the coating layer 20 may decrease, and curing reaction may occur incompletely, resulting in a decrease in the curing speed or strength. If the acid value and/or hydroxyl value exceed the upper limits of the above numerical ranges, curing reaction may occur excessively, which may reduce the stability of the coating composition, and the viscosity of the coating composition may increase, making coating difficult. The acid and hydroxyl values may be calculated based on the number of milligrams of potassium hydroxide required to titrate a sample with a potassium hydroxide solution.

The glass transition temperature (Tg) of the bio-derived modified acrylic resin may be in a range of 40 °C to 50 °C. If the glass transition temperature is lower than 40 °C, the coating composition may become too flexible, resulting in poor adhesion or mechanical properties and reduced resistance to the external environment. If the glass transition temperature exceeds 50 °C, flexibility may decrease and durability may deteriorate.

The weight average molecular weight (Mw) of the bio-derived modified acrylic resin may be in a range of 3,000 g/mol to 6,000 g/mol. When the weight average molecular weight falls within the above numerical range, a coating film may be formed on the coating composition and mechanical properties may be improved.

The bio-derived modified acrylic resin may be in a form mixed with an organic solvent. The solid content of the bio-derived modified acrylic resin may be in a range of 60 wt % to 80 wt % based on the total amount of the bio-derived modified acrylic resin. When the solid content falls within the above range, spray workability of the coating composition may be excellent.

The bio-derived modified acrylic resin may include a polymer of a bio-derived monomer including at least one of butyl acrylate, butyl methacrylate, ethyl acrylate, ethyl methacrylate, isobornyl acrylate, isobornyl methacrylate, isobutyl acrylate, isobutyl methacrylate, lauryl acrylate, or lauryl methacrylate; and a diol compound modified with maleic anhydride. The diol compound is not particularly limited, and may include, for example, 1,3-propanediol.

The solvent may include an acetate-based solvent, a ketone-based solvent, or the like. The solvent may be a solvent having good compatibility with resins and additives, and may serve to lower the viscosity of the coating composition to facilitate coating work. The smoothness and appearance of the coating film may be provided by adjusting the volatilization rate of the solvent.

The curing agent may be used by mixing a general curing agent and a bio-derived curing agent. The general curing agent may include an isocyanate of HDI trimer type. The general curing agent has excellent yellowing resistance and curing properties. The bio-derived curing agent is a bio-derived isocyanate curing agent, which may include 1,5-pentamethylene diisocyanate. The bio-derived curing agent has excellent yellowing resistance and curing properties, but relatively poor chemical resistance, so it is desirable to use the same in combination with a general curing agent. In the embodiment, the bio-based carbon content of the coating composition is further increased through the use of the bio-derived isocyanate curing agent.

The coating composition may further include an additive. The type of additive is not particularly limited, and may include a pigment, an aluminum paste, a reaction catalyst, a matting agent, an anti-settling agent, a surface additive, a wet dispersant, a UV stabilizer, and the like.

The pigment may serve to impart the coating film with a color. The pigment may include carbon black, black iron oxide, black spinel, black titanium pigment, and the like. The aluminum paste may serve to impart the coating film with a metallic color. The reaction catalyst may serve to promote urethane reaction. The matting agent may serve to impart the coating film with gloss. The anti-settling agent may serve to prevent a matting agent, pigment, and the like, from settling. The surface additive is a silicone-based additive and may serve to improve leveling and workability during coating and prevent defects in the coating film such as pinholes, and the like. The wet dispersant may serve to disperse the pigment to make the color of the coating film vivid and prevent the pigment from agglomerating during storage. The UV stabilizer may serve to prevent defects such as loss of gloss, yellowing, cracking, and the like.

When the coating composition constitutes the bottom layer 21, the coating composition may include a main material and a curing agent. The main material may include a range of 10 wt % to 20 wt % of a base resin, a range of 25 wt % to 35 wt % of the bio-derived acrylic resin, a range of 10 wt % to 25 wt % of the bio-derived modified acrylic resin, a range of 1 wt % to 3 wt % of a pigment, a range of 15 wt % to 25 wt % of a solvent, and a range of 5 wt % to 20 wt % of an additive. The amount of the curing agent may be a range of 20 parts by weight to 30 parts by weight based on 100 parts by weight of the main material.

The base resin may include acrylic resin derived from petrochemical products.

If the amount of the base resin is less than 10 wt %, scratch resistance and chemical resistance may deteriorate. If the amount of the base resin exceeds 20 wt %, coating leveling properties may deteriorate.

If the amount of the bio-derived acrylic resin is less than 25 wt %, heat cycling resistance and acid resistance may decrease, whereas if it exceeds 35 wt %, adhesion and moisture resistance may decrease.

If the amount of the bio-derived modified acrylic resin is less than 10 wt %, chemical resistance such as sunscreen resistance, and the like, may decrease, whereas if it exceeds 25 wt %, gloss and compatibility may decrease.

If the amount of the pigment is less than 1 wt %, it is difficult to conceal the color of the substrate 10, whereas if it exceeds 3 wt %, interlayer adhesion may decrease.

The additive may include a range of 5 wt % to 10 wt % of aluminum paste, a range of 0.01 wt % to 0.03 wt % of a reaction catalyst, a range of 0.8 wt % to 2 wt % of an anti-settling agent, a range of 0.1 wt % to 0.5 wt % of a surface additive, a range of 0.5 wt % to 3 wt % of a wet dispersant, a range of 0.5 wt % to 1.5 wt % of a UV stabilizer, and the like. The amount of the additive may be set based on the total weight of the main material.

When the coating composition constitutes the top layer 23, the coating composition may include a main material and a curing agent. The main material may include a range of 30 wt % to 45 wt % of the bio-derived acrylic resin, a range of 15 wt % to 25 wt % of the bio-derived modified acrylic resin, a range of 25 wt % to 40 wt % of a solvent, and a range of 2 wt % to 15 wt % of an additive. The amount of the curing agent may be in a range of 20 parts by weight to 30 parts by weight based on 100 parts by weight of the main material.

If the amount of the bio-derived acrylic resin is less than 30 wt %, heat cycling resistance and acid resistance may decrease, whereas if it exceeds 45 wt %, adhesion and moisture resistance may decrease.

If the amount of the bio-derived modified acrylic resin is less than 15 wt %, chemical resistance such as sunscreen resistance, and the like, may decrease, whereas if it exceeds 25 wt %, gloss and compatibility may decrease.

The additive may include a range of 0.01 wt % to 0.03 wt % of a reaction catalyst, a range of 1 wt % to 6 wt % of a matting agent, a range of 0.8 wt % to 2 wt % of an anti-settling agent, a range of 0.1 wt % to 0.5 wt % of a surface additive, and a range of 0.5 wt % to 1.5 wt % of a UV stabilizer. The amount of the additive may be set based on the total weight of the main material.

The coating composition may have a bio-based carbon content in a range of 15 wt % to 45 wt % based on the total amount of the coating composition. The bio-based carbon content may be measured using a radiocarbon analysis technique according to ASTM D6866 (% bio-based carbon content). The bio-based carbon content may be determined according to EN 16640. The bio-based carbon content of the coating composition is the total organic carbon content (X_{B}^{TOC}) as measured according to ASTM D6866. The coating composition is eco-friendly paint and is characterized by a very high biomass content compared to existing general coating compositions.

A better understanding of various aspects may be obtained through the following examples. These examples are merely set forth to illustrate various aspects and are not to be construed as limiting the scope of various aspects.

### Preparation Example 1—Preparation of Bio-Derived Acrylic Resin

A four-neck flask was equipped with a thermometer, a condenser, a stirrer, and a heater. 42.0 wt % of butyl acetate was placed in the four-neck flask and heated to about 110 °C, after which 13.0 wt % of methyl methacrylate, 20.0 wt % of bio-isobornyl acrylate, 5.0 wt % of normal-butyl methacrylate, 7.5 wt % of 2-hydroxyethyl methacrylate, 0.5 wt % of methacrylic acid, and 0.5 wt % of t-butylperoxy 2-ethylhexanoate were added dropwise at a uniform rate for about 3 hours. The result was maintained for 1 hour, and a mixture of 0.3 wt % of t-butylperoxy 2-ethylhexanoate and 10.0 wt % of butyl acetate was added dropwise for 1 hour. After maintaining the result for 2 hours, the reaction was terminated, obtaining a bio-derived acrylic resin having a bio-based carbon content of about 32 wt %. The bio-derived acrylic resin had a weight average molecular weight of about 9,000 g/mol to 13,000 g/mol, a hydroxyl value of about 60 mgKOH/g to 80 mgKOH/g, and an acid value of 2 mgKOH/g to 5 mgKOH/g.

### Preparation Example 2—Preparation of Bio-Derived Modified Acrylic Resin

A four-neck flask was equipped with a thermometer, a condenser, a stirrer, and a heater. 22.0 wt % of maleic anhydride and 20.0 wt % of bio-1,3-propanediol were placed in the four-neck flask and heated to 60 °C. Thereafter, 60.0 wt % of CARDURA E10P having an acid value of 300 mgKOH/g or less was added and heated to 130 °C. When the temperature was maintained and the acid value was 2 mgKOH/g or less, the result was cooled and packaged, obtaining a bio-derived modified monomer having a bio-based carbon content of about 20 wt %.

A four-neck flask was equipped with a thermometer, a condenser, a stirrer, and a heater. 34.0 wt % of butyl acetate was placed in the four-neck flask and heated to about 126 °C, after which 17.0 wt % of 2-hydroxyethyl methacrylate, 30.0 wt % of bio-isobornyl acrylate, 3.0 wt % of butyl acrylate, 20 wt % of the bio-derived modified monomer, and 3.0 wt % of t-butylperoxy 2-ethylhexanoate were added dropwise at a uniform rate for about 4 hours. The result was maintained for 1 hour, and a mixture of 0.3 wt % of t-butylperoxy 2-ethylhexanoate and 1 wt % of butyl acetate was then added. After maintaining the result for 3 hours, the reaction was terminated, obtaining a bio-derived modified acrylic resin having a bio-based carbon content of about 35 wt %. The bio-derived modified acrylic resin had a weight average molecular weight of about 3,000 g/mol to 6,000 g/mol, a hydroxyl value of about 125 mgKOH/g to 145 mgKOH/g, and an acid value of about 2 mgKOH/g or less.

### Examples 1 to 3 and Comparative Examples 1 to 4—Formation of Bottom Laver

A bottom layer was formed by preparing the coating composition mixed as shown in Tables 2 and 3 below and hydraulically transferring the same onto a substrate.

TABLE 2

| Classification | | Example 1 | Example 2 | Example 3 |
|---|---|---|---|---|
| Main | Base resin | 18 | 10 | 5 |
| material | Bio-derived | 30 | 38 | 40 |
| [wt %] | acrylic resin | | | |
| | Bio-derived | 20 | 20 | 23 |
| | modified acrylic | | | |
| | resin | | | |
| | Pigment | 2 | 2 | 2 |
| | Reaction catalyst | 0.01 | 0.01 | 0.01 |
| | Anti-settling agent | 1 | 1 | 1 |
| | Surface additive | 0.3 | 0.3 | 0.3 |
| | Wet dispersant | 2 | 2 | 2 |
| | Solvent | 26.69 | 26.69 | 26.69 |
| Curing agent | General curing | 20 | 10 | 10 |
| [parts by | agent | | | |
| weight] | Bio-derived curing | — | 10 | 10 |
| | agent | | | |

TABLE 3

| | | Comparative | Comparative | Comparative | Comparative |
|---|---|---|---|---|---|
| Classification | | Example 1 | Example 2 | Example 3 | Example 4 |
| Main | Base resin | 38 | 23 | 18 | 18 |
| material | Bio-derived | 30 | 45 | 10 | 10 |
| [wt %] | acrylic resin | | | | |
| | Bio-derived | — | — | 40 | 40 |
| | modified acrylic | | | | |
| | resin | | | | |
| | Pigment | 2 | 2 | 2 | 2 |
| | Reaction | 0.01 | 0.01 | 0.01 | 0.01 |
| | catalyst | | | | |
| | Anti-settling | 1 | 1 | 1 | 1 |
| | agent | | | | |
| | Surface additive | 0.3 | 0.3 | 0.3 | 0.3 |
| | Wet dispersant | 2 | 2 | 2 | 2 |
| | Solvent | 26.69 | 26.69 | 26.69 | 26.69 |
| Curing agent | General curing | 20 | — | 20 | 10 |
| [parts by | agent | | | | |
| weight] | Bio-derived | — | 20 | — | 10 |
| | curing agent | | | | |

The components in Tables 2 and 3 are as follows:
Base resin: Acrylic resin
Pigment: Carbon Black FW200 from Orion
Reaction catalyst: TL-100 from Songwon Industrial
Anti-setting agent: Modapol-7000 from Hung San Hwa Sung
Surface additive: BYK-306,331 from BYK
Wet dispersant: BYK-2013 from BYK
General curing agent: Desmodur N-3300 from BASF

The bio-based carbon content, sunscreen resistance, moisture resistance, and light resistance of the bottom layer according to each of Examples 1 to 3 and Comparative Examples 1 to 4 were measured and evaluated as follows. The results are shown in Table 4 below.

Bio-based carbon content: Measurement was performed according to the ASTM D6866 test method. According to ASTM D6866, bio-based carbon content is measured by detecting C₁₄, which is absent in petroleum-derived compounds.

Sunscreen resistance: After placing two sheets of white cotton cloth (equivalent to Toyosynthetic CH2070-3) having the same size on an acrylic plate (50 mm×50 mm, width×length), 0.25 g of sunscreen (Nivea SPF47) was applied onto the entire surface. The area where the sunscreen was applied was placed on the coating film and the acrylic plate was pressed and thus came into close contact. After leaving in a constant temperature bath at 80±2 °C for 1 hour, the white cotton cloth and acrylic plate were removed, and the result was allowed to stand at room temperature for 10 minutes. After washing with a neutral detergent and drying, appearance and adhesion of the coating film were evaluated.

Moisture resistance: After removing moisture from the coating specimen allowed to stand at a temperature of 50 °C for 240 hours, appearance and adhesion were determined.

Light resistance: Appearance and adhesion were determined after irradiation under xenon arc-furnace conditions of 1050 kJ/m² (340 nm) or 126 mJ/m² (300 to 400 nm) according to the SAE J 2412 standard. The appearance evaluation for light resistance was performed using a spectrophotometer, and the color difference values (L*a*b*) before and after evaluation were measured and then the difference, ΔE*, was determined.

Adhesion: Adhesion of the final coating film was evaluated by counting the number of peeled marks among 100 marks having a size of 1 mm×1 mm (width×length) according to the ASTM D3359 tape adhesion test method. The test was repeated three times, and adhesion of M-2.5 or more was judged to be Pass according to the ISO 2409 standard.

TABLE 4

| | Comparative Example | | | | Example | | |
|---|---|---|---|---|---|---|---|
| Classification | 1 | 2 | 3 | 4 | 1 | 2 | 3 |
| Bio-based | 10 | 25 | 20 | 22 | 20 | 25 | 35 |
| carbon | | | | | | | |
| content | | | | | | | |
| Appearance | Good | Good | Haze | Haze | Good | Good | Good |
| Sunscreen | M-1.0 | M-3.0 | M-1.0 | M-3.0 | M-1.0 | M-1.0 | M-1.0 |
| resistance | | | | | | | |
| Heat cycling | M-1.0 | M-1.0 | M-1.0 | M-1.0 | M-1.0 | M-1.0 | M-1.0 |
| resistance | | | | | | | |
| Moisture | M-1.0 | M-3.0 | M-3.0 | M-3.0 | M-1.0 | M-1.0 | M-1.0 |
| resistance | ΔE < 1.5 | ΔE < 1.5 | ΔE < 1.5 | ΔE < 1.5 | ΔE < 1.5 | ΔE < 1.5 | ΔE < 1.5 |
| Light | M-1.5 | M-1.0 | M-3.0 | M-5.0 | M-1.0 | M-1.0 | M-1.0 |
| resistance | ΔE < 1.5 | ΔE < 1.5 | ΔE < 1.5 | ΔE < 1.5 | ΔE < 1.5 | ΔE < 1.5 | ΔE < 1.5 |

Comparative Example 1 had goad evaluation properties, but the bio-based carbon content was about 10 wt %, which is not significantly higher than that of the conventional coating composition. Comparative Example 2 had satisfactory bio-based carbon content, but did not satisfy the properties for an automotive interior material due to insufficient chemical resistance. In Comparative Examples 3 and 4, an excess of bio-derived modified acrylic resin was added to increase bio-based carbon content and improve chemical resistance, but the appearance and properties were not satisfactory due to poor compatibility with the bio-derived acrylic resin.

In Comparative Example 4, the proportion of the bio-derived curing agent was increased in the presence of an excess of bio-derived modified acrylic resin in order to maximize the bio-based carbon content. Comparative Example 4 did not satisfy sunscreen resistance (chemical resistance).

In Examples 1 to 3, the optimal proportions of the base resin, the bio-derived acrylic resin, and the bio-derived modified acrylic resin were selected, satisfying the appearance and properties for automotive interior materials and achieving a bio-based carbon content of 20 to 35 wt %.

### Examples 4 to 6 and Comparative Examples 5 to 8—Formation of Top Laver

A top layer was formed by preparing the coating composition mixed as shown in Tables 5 and 6 below and hydraulically transferring the same onto the middle layer.

TABLE 5

| Classification | | Example 4 | Example 5 | Example 6 |
|---|---|---|---|---|
| Main material | Bio-derived | 40 | 40 | 35 |
| [wt %] | acrylic resin | | | |
| | Bio-derived | 20 | 20 | 25 |
| | modified acrylic | | | |
| | resin | | | |
| | Anti-settling | 1 | 1 | 1 |
| | agent | | | |
| | Surface additive | 0.4 | 0.4 | 0.4 |
| | Wet dispersant | 0.2 | 0.2 | 0.2 |
| | UV stabilizer | 1 | 1 | 1 |
| | Reaction catalyst | 0.01 | 0.01 | 0.01 |
| | Matting agent | 5.5 | 5.5 | 5.5 |
| | Solvent | 31.89 | 31.89 | 31.89 |
| Curing agent | General curing | 25 | 12.5 | 8 |
| [parts by | agent | | | |
| weight] | Bio-derived | — | 12.5 | 17 |
| | curing agent | | | |

TABLE 6

| | | Comparative | Comparative | Comparative | Comparative |
|---|---|---|---|---|---|
| Classification | | Example 5 | Example 6 | Example 7 | Example 8 |
| Main | Bio-derived | 60 | — | 50 | 40 |
| material | acrylic resin | | | | |
| [wt %] | Bio-derived | — | 50 | 10 | 20 |
| | modified | | | | |
| | acrylic resin | | | | |
| | Anti-settling | 1 | 1 | 1 | 1 |
| | agent | | | | |
| | Surface | 0.4 | 0.4 | 0.4 | 0.4 |
| | additive | | | | |
| | Wet dispersant | 0.2 | 0.2 | 0.2 | 0.2 |
| | UV stabilizer | 1 | 1 | 1 | 1 |
| | Reaction | 0.01 | 0.01 | 0.01 | 0.01 |
| | catalyst | | | | |
| | Matting agent | 5.5 | 5.5 | 5.5 | 5.5 |
| | Solvent | 31.89 | 41.89 | 31.89 | 31.89 |
| Curing agent | General curing | 25 | 25 | — | — |
| [parts by | agent | | | | |
| weight] | Bio-derived | — | — | 25 | 25 |
| | curing agent | | | | |

The components of Tables 5 and 6 are as follows:
Anti-settling agent: Modapol-7000 from Hung San Hwa Sung
Surface additive: BYK-306,331 from BYK
Wet dispersant: BYK-2013 from BYK
UV Stabilizer: TINUVIN #1130, #292 from BASF
Reaction catalyst: TL-100 from Songwon Industrial
Matting agent: NIPSIL E-220A from TOSOH SILICA
General curing agent: Desmodur N-3300 from BASF

The bio-based carbon content, sunscreen resistance, moisture resistance, and light resistance of the top layer according to each of Examples 4 to 6 and Comparative Examples 5 to 8 were measured and evaluated as described above. The results are shown in Table 7 below.

TABLE 7

| | Comparative Example | | | | Example | | |
|---|---|---|---|---|---|---|---|
| Classification | 5 | 6 | 7 | 8 | 4 | 5 | 6 |
| Bio-based | 20 | 25 | 35 | 35 | 20 | 30 | 40 |
| carbon | | | | | | | |
| content | | | | | | | |
| Appearance | Poor | Light | Good | Good | Good | Good | Good |
| | leveling | stain | | | | | |
| Sunscreen | M-3.0 | M-1.0 | M-3.0 | M-3.0 | M-1.0 | M-1.0 | M-1.0 |
| resistance | | | | | | | |
| Heat cycling | M-1.0 | M-1.0 | M-1.0 | M-1.0 | M-1.0 | M-1.0 | M-1.0 |
| resistance | | | | | | | |
| Moisture | M-3.0 | M-1.0 | M-3.0 | M-1.0 | M-1.0 | M-1.0 | M-1.0 |
| resistance | ΔE < 1.5 | ΔE < 1.5 | ΔE < 1.5 | ΔE < 1.5 | ΔE < 1.5 | ΔE < 1.5 | ΔE < 1.5 |
| Light | M-1.5 | M-5.0 | M-1.5 | M-1.5 | M-1.5 | M-1.5 | M-1.5 |
| resistance | ΔE < 1.5 | ΔE < 1.5 | ΔE < 1.5 | ΔE < 1.5 | ΔE < 1.5 | ΔE < 1.5 | ΔE < 1.5 |

In Comparative Example 5 using the bio-derived acrylic resin alone, the appearance leveling quality deteriorated due to quick drying, and the properties for an automotive interior material were unsatisfactory due to insufficient chemical resistance of the coating film.

In Comparative Example 6 using the bio-derived modified acrylic resin alone, appearance (light stain) quality deteriorated due to slow drying, and coating properties were poor in terms of light resistance.

In Comparative Examples 7 and 8, the bio-based carbon content was intended to be obtained as desired by mixing the bio-derived acrylic resin and the bio-derived modified acrylic resin and using the bio-derived curing agent, but the properties for automotive interior materials were unsatisfactory due to insufficient chemical resistance. The use of the bio-derived curing agent alone resulted in insufficient properties, especially chemical resistance.

In Examples 4 to 6, the proportions of the bio-derived acrylic resin and the bio-derived modified acrylic resin were optimized, satisfying the appearance/properties for automotive interior materials and achieving a bio-based carbon content of 20 wt % to 40 wt %.

### Example 7

A glossy top layer was formed by removing the matting agent from the composition of Example 6 to prepare the coating composition mixed as shown in Table 8 below, and hydraulically transferring the same onto the middle layer.

TABLE 8

| Classification | | Example 7 |
|---|---|---|
| Main material | Bio-derived acrylic resin | 35 |
| [wt %] | Bio-derived modified | 25 |
| | acrylic resin | |
| | Anti-settling agent | 1 |
| | Surface additive | 0.4 |
| | Wet dispersant | 0.2 |
| | UV stabilizer | 1 |
| | Reaction catalyst | 0.01 |
| | Solvent | 37.39 |
| Curing agent | General curing agent | 8 |
| [parts by | Bio-derived curing agent | 17 |
| weight] | | |

The bio-based carbon content in the top layer according to Example 7 was about 47 wt %.

### Test Example

A coating layer was formed on a substrate by controlling the color of the bottom layer, the gloss of the top layer, and the bio-based carbon content in the bottom and top layers as shown in Table 9 below. The appearance and properties of the coating layer were evaluated.

TABLE 9

| | | | Bio-based | | | |
|---|---|---|---|---|---|---|
| | | | carbon content | | | |
| | | | Bottom | Top | | |
| | Color of | Gloss of | layer | layer | | |
| Classification | bottom layer | top layer | [wt %] | [wt %] | Appearance | Properties |
| 1 | Black | Semi-gloss | 20 | 30 | Good | Good |
| 2 | Black | Semi-gloss | 20 | 40 | Good | Good |
| 3 | Black | Semi-gloss | 35 | 40 | Good | Good |
| 4 | Black | Gloss | 20 | 20 | Good | Good |
| 5 | Black | Gloss | 23 | 20 | Good | Bad |
| 6 | Black | Gloss | 20 | 25 | Good | Bad |
| 7 | Silver | Semi-gloss | 25 | 30 | Good | Good |
| 8 | Silver | Semi-gloss | 25 | 40 | Good | Good |
| 9 | Silver | Gloss | 15 | 30 | Good | Good |
| 10 | Silver | Gloss | 25 | 45 | Good | Good |

Specimens 5 and 6 showed somewhat poor light resistance and adhesion.

As is apparent from the foregoing, the coating composition capable of providing durability properties required for automobiles and increasing the bio-based carbon content in paint can be obtained.

The coating composition having excellent coating properties such as adhesion, sunscreen resistance, heat resistance, moisture resistance, light resistance, and the like, can be obtained.

Various aspects are not limited to the foregoing. It should be understood that the effects of various aspects include all effects that can be inferred from the description of various aspects.

Although specific embodiments have been described, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. A coating composition, comprising:
a bio-derived acrylic resin; and
a bio-derived modified acrylic resin.

2. The coating composition of claim 1, wherein the bio-derived acrylic resin comprises a bio-based carbon content in a range of 30 wt % to 35 wt %.

3. The coating composition of claim 1, wherein an acid value of the bio-derived acrylic resin is in a range of 2 mgKOH/g to 5 mgKOH/g.

4. The coating composition of claim 1, wherein a hydroxyl value of the bio-derived acrylic resin is in a range of 60 mgKOH/g to 80 mgKOH/g.

5. The coating composition of claim 1, wherein a glass transition temperature (Tg) of the bio-derived acrylic resin is in a range of 80 °C to 100 °C.

6. The coating composition of claim 1, wherein a weight average molecular weight (Mw) of the bio-derived acrylic resin is in a range of 9,000 g/mol to 13,000 g/mol.

7. The coating composition of claim 1, wherein a solid content of the bio-derived acrylic resin is in a range of 40 wt % to 50 wt %.

8. The coating composition of claim 1, wherein the bio-derived acrylic resin comprises a polymer of a bio-derived monomer comprising one or more of butyl acrylate, butyl methacrylate, ethyl acrylate, ethyl methacrylate, isobornyl acrylate, isobornyl methacrylate, isobutyl acrylate, isobutyl methacrylate, lauryl acrylate or lauryl methacrylate.

9. The coating composition of claim 1, wherein the bio-derived modified acrylic resin comprises a bio-based carbon content in a range of 30 wt % to 40 wt %.

10. The coating composition of claim 1, wherein an acid value of the bio-derived modified acrylic resin is 2 mgKOH/g or less.

11. The coating composition of claim 1, wherein a hydroxyl value of the bio-derived modified acrylic resin is in a range of 125 mgKOH/g to 145 mgKOH/g.

12. The coating composition of claim 1, wherein a glass transition temperature (Tg) of the bio-derived modified acrylic resin is in a range of 40 °C to 50 °C.

13. The coating composition of claim 1, wherein a weight average molecular weight (Mw) of the bio-derived modified acrylic resin is in a range of 3,000 g/mol to 6,000 g/mol.

14. The coating composition of claim 1, wherein a solid content of the bio-derived modified acrylic resin is in a range of 60 wt % to 80 wt %.

15. The coating composition of claim 1, wherein the bio-derived modified acrylic resin comprises a polymer of a bio-derived monomer comprising one or more of butyl acrylate, butyl methacrylate, ethyl acrylate, ethyl methacrylate, isobornyl acrylate, isobornyl methacrylate, isobutyl acrylate, isobutyl methacrylate, lauryl acrylate or lauryl methacrylate; and a diol compound modified with maleic anhydride.

16. The coating composition of claim 1, wherein the coating composition further comprises a curing agent, wherein the curing agent comprises a bio-derived isocyanate curing agent.

17. The coating composition of claim 1, wherein:
the coating composition comprises a main material and a curing agent,
wherein the main material comprises a range of 10 wt % to 20 wt % of a base resin, a range of 25 wt % to 35 wt % of the bio-derived acrylic resin, a range of 10 wt % to 25 wt % of the bio-derived modified acrylic resin, a range of 1 wt % to 3 wt % of a pigment, a range of 15 wt % to 25 wt % of a solvent, and a range of 5 wt % to 20 wt % of an additive, and
wherein the coating composition comprises a range of 20 parts by weight to 30 parts by weight of the curing agent based on 100 parts by weight of the main material.

18. The coating composition of claim 1, wherein:
the coating composition comprises a main material and a curing agent,
wherein the main material comprises a range of 30 wt % to 45 wt % of the bio-derived acrylic resin, a range of 15 wt % to 25 wt % of the bio-derived modified acrylic resin, a range of 25 wt % to 40 wt % of a solvent, and a range of 2 wt % to 15 wt % of an additive, and
wherein the coating composition comprises a range of 20 parts by weight to 30 parts by weight of the curing agent based on 100 parts by weight of the main material.

19. The coating composition of claim 1, wherein the coating composition comprises a bio-based carbon content in a range of 15 wt % to 45 wt %.

20. An automotive interior material, comprising:
a substrate; and
a coating layer including a multilayer structure disposed on the substrate,
wherein the coating layer comprises a bottom layer disposed on the substrate; a middle layer disposed on the bottom layer; and a top layer disposed on the middle layer, and
wherein at least one of the bottom layer or the top layer comprises the coating composition of claim 1.
